(19) United States
(12) Patent Application Publication
(10) Pub. No.: US 2020/0330937 A1
(43) Pub. Date: Oct. 22, 2020

(54) DEVICE AND METHOD FOR THE PRODUCTION OF EMULSIONS

(71) Applicant: The Procter & Gamble Company, Cincinnati, OH (US)

(72) Inventors: Raul Rodrigo-Gomez, Brussels (BE); Yousef Georges Aouad, Cincinnati, OH (US); Timothy Roy Nijakowski, Mason, OH (US); Gavin John Broad, Liberty Township, OH (US); Jianjun Feng, West Chester, OH (US)

(21) Appl. No.: 16/851,129

(22) Filed: Apr. 17, 2020

Related U.S. Application Data
(60) Provisional application No. 62/835,005, filed on Apr. 17, 2019.

(51) Int. Cl. B01F 11/00; B01J 13/18; B01F 3/08

(52) U.S. Cl. CPC B01F 11/0045; B01J 13/18; B01F 15/0243; B01F 3/0819; B01F 3/0811

(57) ABSTRACT

A device and method of using the device for high throughput production of emulsions having low coefficient of variation droplet/particle sizes.

### FIELD OF THE INVENTION

The present invention relates to a device and method for producing emulsions having droplets/particles with minimal size deviation and at increased production.

### BACKGROUND OF THE INVENTION

Membrane emulsification is a process to produce an emulsion, foam, or dispersion, of one liquid phase (such as oil) in a second immiscible liquid phase (such as water). The process usually employs shear at the surface of the membrane to detach the dispersed phase liquid drops from the membrane surface, after which they become dispersed in the immiscible continuous phase. In many cases the liquid drops are then solidified (e.g via polymerization), to produce solid particles.

Examples of such products include: calibration materials, food and flavor encapsulates, controlled release depots under the skin, ion exchange resins, etc The size of the droplets is dictated by the imbalance of detachment forces, such as shear stress at the surface of the membrane, buoyancy, inertial force, etc.; and cohesive forces, such as interfacial tension and viscous forces. Emulsions with particles of substantially uniform size show greater efficacy for delivering benefits that are not obtained from broad particle size distributions. Where only certain particle sizes are desired, particle size distributions with minimal size deviation are required for various applications such as the production of ion-exchange resins, conditioning treatments, phase exchange materials, surface softening chemistry, fragrance delivery, moisturization agents, antiperspirant actives, or manufacturing processes involving molding or extrusion.

However, known processes which comprise a dispersed and continuous phase generally provide non-uniform droplets/particles in a relatively broad size range. Subsequent screening steps are thus necessary to provide particles in several more restricted size ranges, which entails significant screening and storage costs, as well as the rejection of commercially unusable particles produced.

Uniform droplets may be produced by various known devices comprising for example calibrated tubes or vibrating nozzles which must be adapted to the droplet size required in each case and are not particularly suitable for industrial manufacturing processes.

For industrial scale manufacturing of dispersed phase droplets or particles having little deviation in size, greater throughput is required than what the currently disclosed devices processes can provide. One way increased throughput can be achieved is by increasing the size of membranes consequently increasing the number of pores. However, increasing the size (surface area) of a membrane causes a greater fluid pressure gradient across its expanse thus leading to increased particle size variance. Fluid pressure on the membrane will be greatest at the fluid entry point to the membrane and decrease as the fluid travels farther away from the entry point.

The larger the membrane surface the greater potential for deformations and/or distortions of the membrane surface resulting from the pressure applied to the disperse phase to propel it through the entirety of the membrane expanse; such deformation can lead to “membrane bulge”.

Such membrane bulge can cause the size of the formed droplets to change owing to the difference of the shear stress of the continuous phase flowing over the membrane bulge versus the shear stress of the continuous phase flowing over a flat, unbulged membrane. The resulting shear stress variation leads to variance in the droplet size. As bulge of the membrane increases, droplet detachment forces become non-uniform leading to increased particle size variance or ultimately failure to emulsify under extreme conditions.

An attempt for increasing throughput has been through the use of cylindrical membranes, such as disclosed in U.S. Pat. No. 9,415,530. But, cylindrical membranes as described in U.S. Pat. No. 9,415,530 have a low surface to volume ratio. The cylinder external surface is where the membrane is located, while the volume of the cylinder is used to distribute the disperse phase liquid to the membrane. Thus, a low ratio of surface to volume may mean the pressure drop generated in the disperse phase liquid will be high, leading to dispersed phase pressure variation along the membrane surface, negatively affecting the throughput. Consequently, cylindrical membranes fail to deliver high throughput with low particle size variation due to difficulty in equally distributing fluid to the full area of the membrane with equal pressure. With this geometric configuration, a pressure gradient in the disperse phase liquid will occur before reaching the back part of the membrane at different distances from the point of fluid inlet. This pressure gradient difference can be higher than 10%, causing droplet/particle size variance.

In view of the above, production of particles of a uniform size and at industrial scale is needed.

### SUMMARY OF THE INVENTION

An emulsion forming device is provided that comprises an outer compartment; a dispersed phase droplet forming apparatus; a membrane having one or more pores, an outer surface area and an inner surface area, an average thickness, disposed between the outer compartment and the dispersed phase droplet forming apparatus; wherein the membrane has a bulge index from about 0.1 to about 10 times the average membrane thickness.

A method of producing emulsions is provided that comprises providing an emulsion forming device having an outer compartment; a dispersed phase droplet forming apparatus; a membrane having one or more pores, an outer surface area and an inner surface area, an average thickness disposed between the outer compartment and the dispersed phase droplet forming apparatus; wherein the membrane has a bulge index from about 0.1 to about 10 times the average membrane thickness; wherein a disperse phase is in contact with the inner surface area of the membrane and a continuous phase is in contact with the outer surface area of the membrane; propelling the dispersed phase through the membrane pores into the continuous phase forming an emulsion comprising a plurality of dispersed phase droplets in the continuous phase.

### BRIEF DESCRIPTION OF THE DRAWINGS

FIG. 1 illustrates a perspective view of a device according to some embodiments of the present invention.

FIG. 2 illustrates a cross-sectional view of a device according to some embodiments of the present invention along cross-sectional line 2-2, as shown in FIG. 1.

FIG. 3 illustrates a perspective view of a manifold according to some embodiments of the present invention.

FIG. 4 illustrates a cross-sectional view of a manifold according to some embodiments of the present invention along cross-sectional line 4-4, as shown in FIG. 3.

FIG. 5 illustrates a perspective view of membrane tiles and membrane frames according to some embodiments of the present invention.

FIG. 6 illustrates a micrograph image of a membrane according to some embodiments of the invention.

FIG. 7 illustrates a closeup micrograph image of a membrane according to some embodiments of the invention.

FIG. 8 illustrates a cross-sectional view of a membrane pore according to some embodiments of the present invention.

FIG. 9 is an illustration of membranes pores according to some embodiments of the present invention.

### DETAILED DESCRIPTION OF THE INVENTION

The present invention relates to one or more devices and methods for using such devices to produce emulsions with droplets having a low coefficient of variation with a high throughput. The devices and methods as described herein overcome the deficiencies of the prior art, by in certain aspects, providing a larger membrane surface area when compared to membranes of the prior art, allowing for increased emulsion production; while controlling for deformation of the membrane (bulge) and trans-membrane pressure differences, thus facilitating production of emulsion droplets having a uniform size (low coefficient of variation).

As used herein, the word “or” when used as a connector of two or more elements is meant to include the elements individually and in combination; for example X or Y, means X or Y or both.

As used herein, the articles “a” and “an” are understood to mean one or more of the material that is claimed or described, for example, “an oral care composition” or “a bleaching agent.”

All percentages and ratios used herein after are by weight of total composition (wt %), unless otherwise indicated. All percentages, ratios, and levels of ingredients referred to herein are based on the actual amount of the ingredient, and do not comprise solvents, fillers, or other materials with which the ingredient may be combined as a commercially available product, unless otherwise indicated.

All measurements referred to herein are made at about 23° C. (i.e. room temperature) unless otherwise specified.

Surprisingly, by the practice of the present invention, exceptionally uniform droplets can be produced with a high throughput. When the droplets comprise monomers, polymerization of the uniform droplets form unexpectedly uniform particles. For example, in embodiments, the present invention provides spheroidal droplets having a volume average droplet diameter (i.e., the mean diameter based on the unit volume of the droplet population) between about 1 μm to about 250 μm. In some embodiments, the droplets have an a substantially homogenous composition throughout their volume. In embodiments, droplets can have a diameter of greater than 1 μm. In embodiments, droplets can have a mean diameter of greater than 1 μm (in volume weighted distribution). In any of the forgoing embodiments, the referenced diameter can be greater than or equal to 1 μm, 2 μm, 3 μm, 4 μm, 5 μm, 10 μm, 15 μm, 20 μm, or 25 μm. In any of the foregoing embodiments, the referenced diameter can be about 1 μm to 100 μm, or 1 μm to 80 μm, or 1 μm to 65 μm, or 1 μm to 50 μm, or 5 μm to 80 μm, or 10 μm to 80 μm, or 10 μm to 65 μm, or 15 μm to 65 μm, or 20 μm to 50 μm. For example, the referenced diameter can be about 1 μm, 2 μm, 3 μm, 4 μm, 5 μm, 10 μm, 15 μm, 20 μm, 25 μm, 30 μm, 35 μm, 40 μm, 50 μm, 55 μm, 60 μm, 65 μm, 70 μm, 75 μm, 80 μm, 85 μm, 90 μm, 95 μm, or 100 μm. In embodiments, droplets can have a diameter of greater than 1 μm, 2 μm, 3 μm, 4 μm, 5 μm, or 10 μm. In embodiments, droplets can include a diameter of 1 μm to 80 μm, 3 μm to 80 μm, or 5 μm to 50 μm, or 10 μm to 50 μm. The volume average droplet diameter can be measured by any conventional method, for example, using optical imaging (dynamic or static), laser/light diffraction, light extinction or electrozone sensing or combinations thereof.

In another embodiment, the droplets are exceptionally uniform having a droplet coefficient of variation (“CoV”) based on volume percent of less than 50%, or less than 45%, or less than 40%, or less than 35%, or less than 30%, or less than 25%, or less than 20%. For example, the droplets diameter CoV based on volume percent of about 20% to about 50%, or about 25% to about 40%, or about 20% to about 45%, or about 30% to about 40%. The diameter CoV based on volume percent (CoVv) is calculated from the following equation:

$$CoVv ( \% ) = \frac{{σ}_{v}}{{μ}_{v}} * 100$$

$${σ}_{v} = {( {\sum }_{i = 1 um}^{493.3 um} ( {x}_{i , v} * {( {d}_{i} - {μ}_{v} )}^{2} ) )}^{0.5}$$

$${μ}_{v} = \frac{{\sum }_{i = 1 um}^{493.3 um} ( {x}_{i , v} * {d}_{i} )}{{\sum }_{i = 1 um}^{493.3 um} {x}_{i , v}}$$

### Where:

σᵥ—Standard deviation of distribution of volume distribution
μᵥ—mean of the distribution of volume distribution
dᵢ—diameter in fraction i
x_{i,v}—frequency in fraction i (corresponding to diameter i) of volume distribution

In embodiments, the droplets can have a diameter coefficient variation based on number percent of about 1% to about 150%, or about 1% to about 100%, or about 10% to about 100%, or about 10% to about 80%, or about 10% to about 50%. For example, the droplets can have a diameter coefficient of variation based on number percent of about 1%, 5%, 10%, 15%, 20%, 25%, 30%, 35%, 40%, 45%, 50%, 60%, 70%, 80%, 90%, 100%, or 150%. The number population diameter coefficient of variation (CoVn) can be calculated by the following equation:

$$CoVn ( \% ) = \frac{{σ}_{n}}{{μ}_{n}} * 100$$

### Wherein:

$${σ}_{n} = {( {\sum }_{i = 1 um}^{493.3 um} ( {x}_{i , n} * {( {d}_{i} - {μ}_{n} )}^{2} ) )}^{0.5}$$

$${μ}_{n} = \frac{{\sum }_{i = 1 um}^{493.3 um} ( {x}_{i , n} * {d}_{i} )}{{\sum }_{i = 1 um}^{493.3 um} {x}_{i , n}}$$

### Where:

σᵥ—Standard deviation of distribution of number distribution
μᵥ—mean of the distribution of number distribution
dᵢ—diameter in fraction i
x_{i,n}—frequency in fraction i (corresponding to diameter i) of number distribution

$${x}_{i , n} = \frac{{n}_{i}}{{\sum }_{i = 1 um}^{493.3 um} {n}_{i}}$$

The relationship between number and volume distribution is represented by the following equation:

$${x}_{i , v} = \frac{{x}_{i , n} * {d}_{i}^{3}}{{Σ}_{i = 1 um}^{493.3 um} ( {x}_{i , n} * {d}_{i}^{3} )}$$

In embodiments the present invention can provide droplets having a narrow droplet size distribution with a coefficient of variation based on volume diameter of about 20% to about 50%, with a throughput of disperse phase of at least about 5 kg/h.

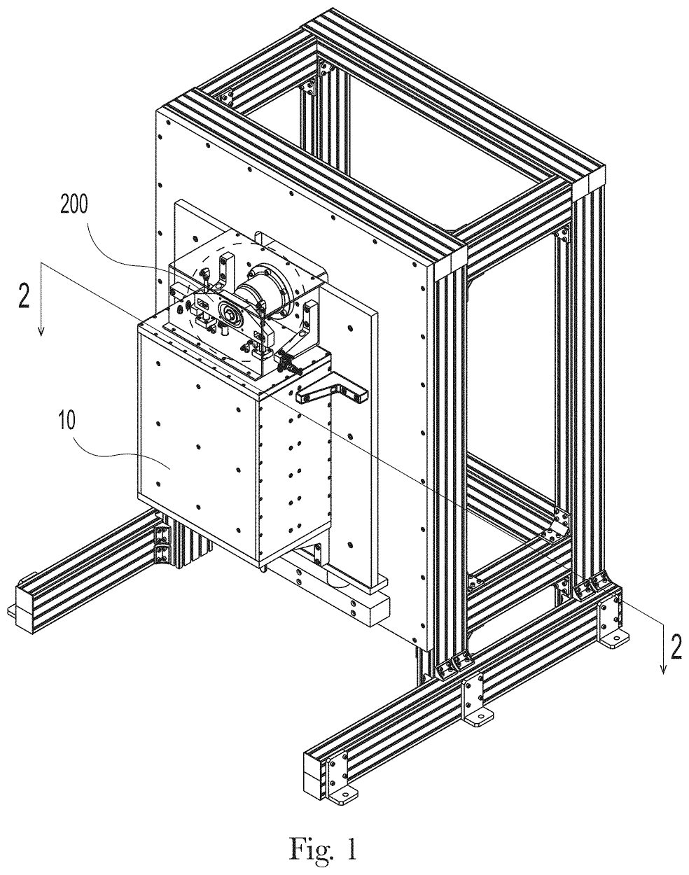

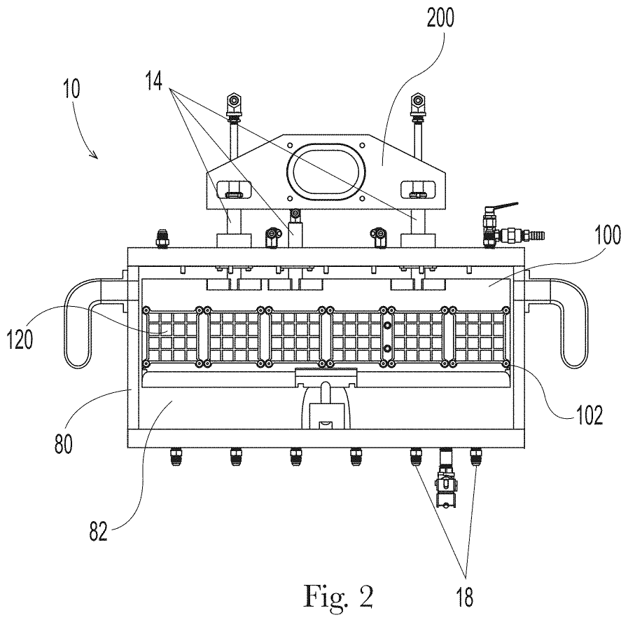

FIG. 1 and FIG. 2 depict an embodiment of the present invention comprising an emulsion forming device 10 useful for preparing droplets having a low droplet coefficient of variation with a high throughput. As illustrated in FIG. 2, device 10 includes a disperse phase input means, which in the depicted embodiment is in the form of disperse phase feed conduits 14 that are in fluid communication with a source of disperse phase. Device 10 also includes a continuous phase input means, for a continuous phase containing a liquid immiscible with the disperse phase, which in the depicted embodiment is in the form of continuous liquid supply conduits 18 that are in fluid communication with a source of continuous phase.

The device 10 comprises an outer shell 80 forming an outer compartment 82, within which is disposed a dispersed phase droplet forming apparatus, such as a manifold 100 having membrane tile holders 102, wherein the membrane tile holders 102 serve to hold one or more membrane tiles 120 that are in fluid contact with a disperse phase and continuous phase. The device accomplishes at least three main design considerations: 1) the mass must be kept to a minimum to keep the inertial loading of a drive mechanism to a minimum; 2) the material forming the manifold must be compatible with the disperse phase and continuous phase; and 3) to ensure laminar flow of the fluids in the outer compartment of the device to avoid shearing of the emulsion.

The manifold may be made from any suitable material that is compatible with the disperse phase, such as Delrin® which has a density of 1.4 g/cm3; polyoxymethylene, also known as acetal, polyacetal, and polyformaldehyde (which is an engineering thermoplastic used in precision parts requiring high stiffness, low friction, and excellent dimensional stability). Stainless steel could also be considered.

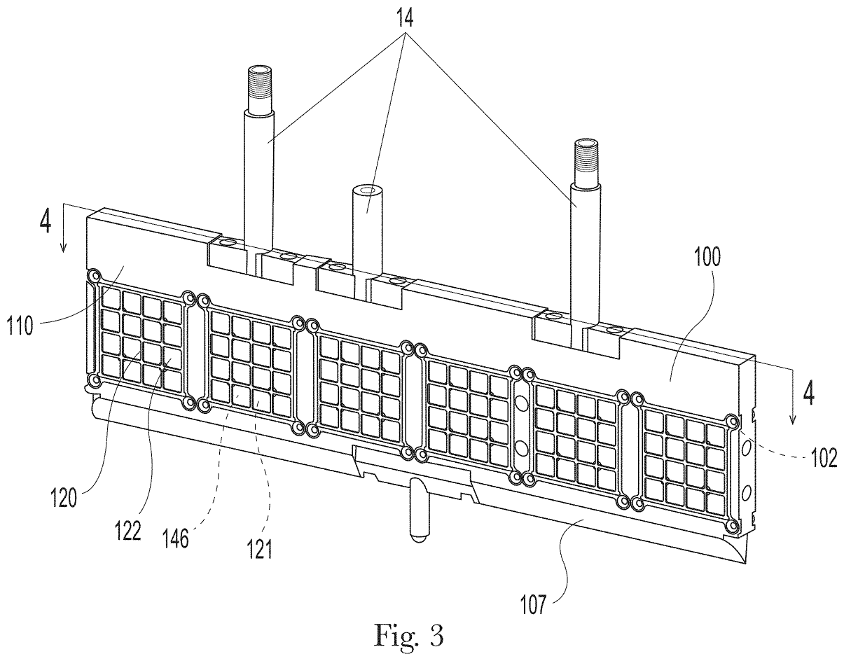

To avoid turbulence and ensure laminar flow within the outer compartment 82, in embodiments, surfaces that are in a plane of movement substantially perpendicular to the flow of dispersed phase through a membrane and that may be become at least partially submersed in the continuous phase, such as the bottom edge of the manifold 107 have been designed to reduce the potential creation of turbulence; for example as shown in FIG. 3 the bottom edge of the manifold 107 has been beveled such that the surface is at most 450 from the plane of the manifold 100. Other forms of turbulence reduction and promotion of laminar flow are envisioned within the scope of the present invention, such as surface coatings, surface modifications, smooth or rounded surfaces. In addition, the membrane tiles 120 are mounted on the membrane tile holders 102 of the manifold 100, which are recessed into the manifold outer surface 110, such that the membrane tile outer surface 122 is substantially flush with the manifold outer surface 110. By having the membrane tile outer surface 122 substantially flush with the manifold outer surface 110 ensures laminar flow is maintained within the outer compartment 82 during emulsion formation, thus helping to ensure consistent droplet formation.

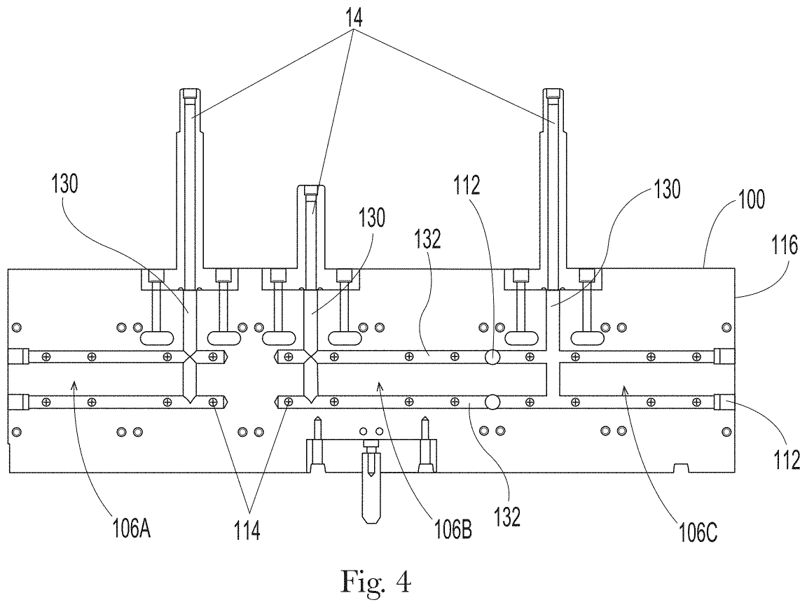

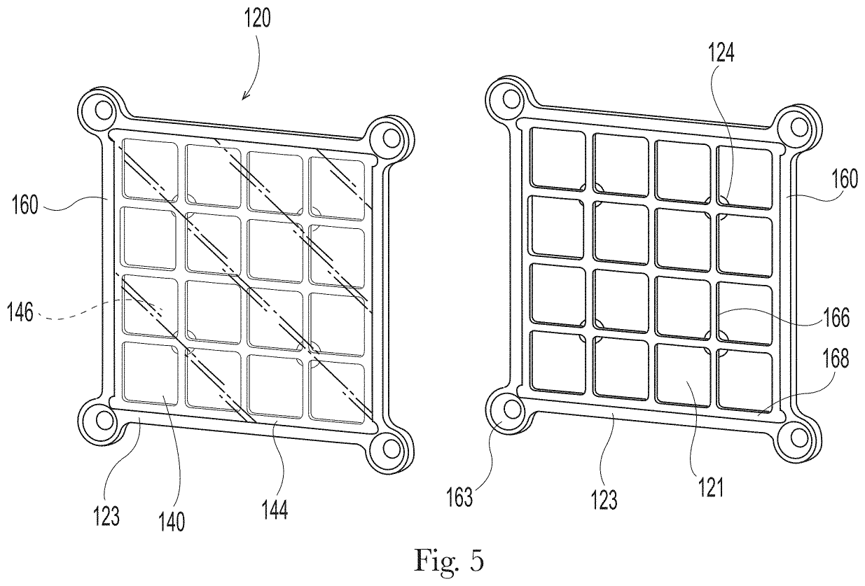

FIG. 4 shows a section cut through the center of a manifold 100. The manifold 100 is split into three separate zones 106A, 106B and 106C where three separate disperse phases could be pumped making an emulsion with multiple disperse phases or a single disperse phase. Each zone comprises an intake port 130, in fluid communication with one or more disperse phase feed conduits 14, for introduction of the disperse phase into the manifold 100, one or more conduits 132, and one or more feed ports 114; while FIG. 4 shows a single intake port 130 per zone there may be more than one and each intake port may connect to the manifold at different points. From the intake port 130 the disperse phase may flow through or across the manifold 100 via one or more conduits 132 which are fluidly connected with an intake port 130 and a disperse phase feed conduit 14. Each zone 106A-C is separated from another zone such that there is little to no mixing of the dispersed phase supplied to one zone with the dispersed phase supplied to a separate zone. One manner of separating a zone from another zone is through the use of cross-drilling plugs 112; however other means of separation are encompassed within the scope of the invention, such as forming the conduits in a manner where they don't connect. Cross-drilling plugs 112, or any other conventional means, can be used prevent the disperse phase from exiting at the edges of the manifold 116 and to prevent mixing between zones 106A, 106B and 106C. The only path for the disperse phase is to flow through feed ports 114 to the corresponding feed holes 124 in a membrane frame 160, as shown in FIG. 5.

With reference to FIG. 5 a membrane tile 120 includes a membrane 140 and membrane frame 160 which forms the borders 123 and sectors 121 of the membrane tile 120. A membrane frame 160 is dimensioned to nest a membrane 140, such that the membrane 140 is in substantial contact with the membrane frame ribs 166 and membrane frame edge 168. A membrane frame 160 also comprises one or more feed holes 124 and may also include an attachment means 163 that allows a membrane tile 120 to be removably or permanently connected to a manifold 100 surface, such as the tile holder 102. Membrane frames may be fastened to the tile holder 102 of the manifold by any conventional means, such as threaded screws, rivets, or adhesives. While FIGS. 2 and 3 show the membrane tiles 120 in a grid-like pattern, membrane tiles may be arranged along a manifold in any arrangement allowing for the production of the desired droplets at the desired throughput.

With reference back to FIG. 5, membrane frames 160 may be made from any suitable material, such as stainless steel or Kapton®; and are dimensioned to contact a membrane 140 around or about the membrane periphery 144 to provide a seal, such that disperse phase, provided to the membrane tile 120, will not be extruded from the membrane tile 120, except through the membrane pores. The membrane frames 160 also comprise membrane frame edges 168 for nesting of the membrane 140 and one or more raised areas or ribs 166, which in this embodiment are shown in a horizontal and vertical orientation forming a grid-like pattern, which when in contact with the membrane inner 146 surface form membrane tile sectors 121. While in FIG. 5 a series of horizontal and vertical ribs 166 are shown, the invention is not limited to a grid-like pattern, as any usable orientation of ribs is within the scope of this invention. In addition, the width, shape and height of the ribs may vary along with the sectors they form with the membrane. The size and dimensions of the sectors may vary, but in embodiments the surface area of a sector as measured along the inside surface of the ribs forming the sides of the sector, may be from about 400 mm² to about 4 mm^{2, 350} mm² to about 10 mm², 300 mm² to about 20 mm², 250 mm² to about 40 mm², or 200 mm² to about 60 mm². Rib height may from about 1 mm to 5 mm or about 2 mm to 4 mm. The sector volume can range from about 100 mm³ to about 500 mm³, 150 mm³ to about 400 mm³, 200 mm³ to about 300 mm³. In addition, in embodiments, the ratio of sector volume to membrane surface area may be about 0.5 to about 2.0, about 0.75 to about 1.5, or about 0.9 to about 1.25.

Membranes may be attached to membrane frames using any means known in the art, for example laser welding or adhesives. A membrane may have any suitable surface area, for example from about 400 cm² to about 10 cm², about 350 cm² to about 20 cm², about 300 cm² to about 40 cm², about 250 cm² to about 60 cm², about 200 cm² to about 80 cm², about 150 cm² to about 100 cm². The attachment of the membrane perimeter 144 along the membrane frame edges 168 provides a hermetic seal; in addition to the perimeter 144, the membrane is attached along the ribs, by any suitable means, as noted above. The attachment of the membrane to the frame along the perimeter and ribs maintains the flatness of the membrane when subjected to trans-membrane pressure during operation. Membrane bulge disrupts shear stress and makes shears stress non-uniform across the membrane. Non-uniform shear stress results in non-uniform droplet sizes. Membrane bulge is defined as the maximum normal deformation of membrane under transmembrane pressure from the static and pre-stress-free status. Membrane bulge may be measured using the method described below:
1. Attach a membrane frame (160) to a manifold (100) using screw fasteners, such as M4×8 mm long in the four corners and tighten to 3.4 Nm of torque. A spacing of 78 mm between centers of a manifold of 90 mm×90 mm will provide a load of 9.1 kN which is sufficient to compress the o-ring seals to provide a seal between the manifold and membrane frame, so as to reduce any potential leaking of compressed air between the manifold and membrane frame. The o-ring seals are made from a 70A shore hardness to meet ASTM D2000, SAE J200 specifications.
   The manifold is made from 6061 grade aluminum with 2 horizontal cross drillings of 1/8NPT allowing entry for the compressed air that is coincident with 4 vertical holes of 6 mm in diameter. The compressed air is supplied from either a central in-house supply or a small portable pump that is capable of providing a minimum of 1 bar pressure to the side of the membrane attached to the membrane frame.
2. Identify the centroid of each unsupported membrane area. As an example, if the unsupported area of membrane is 1.5 cm×1.5 cm the centroid would be the intersecting point of 0.75 cm from a side then 0.75 from an edge that is perpendicular from the first edge.
3. Place a dial indicator plunger directly over the centroid of the membrane area to be measured, with the plunger touching the membrane surface at the centroid, but without any pressure being applied to the membrane. Wherein the dial indicator is mounted to a ridge frame that would not deflect from the forces of the internal spring of the dial indicator selected for the task, such as a Starrett 653GJ Dial Comparator with granite base (The L. S. Starrett Company, Athol, Mass.).
4. Set dial indicator to read zero.
5. Apply the 1 bar of pressure to the membrane.
6. Take a reading from the dial indicator after ten seconds of delay to ensure inflation is complete. Take a reading from the indicator while the pressure is still being applied, this is the deflection produced by the 1 bar of differential pressure. Repeat this test for each sector of the membrane. Each sector deflection must then be evaluated against the average thickness of the membrane, so with a 0.1 mm membrane the index or bulge (indicator reading) of between 0.1 mm to 1 mm if any of the indices need to be below the maximum.
7. Determine Bulge Index—divide measured deflection by the average membrane thickness.

The thickness of the membrane may be measured by using a micrometer Mitutoyo 293-831-30 (Mitutoyo USA Co., Aurora, Ill.), or equivalent, by recording at least 5 individual measurement at different points of the membrane. During operation the membrane may have bulge index in the range for example from about 0.1 to about 10 times the average membrane thickness, or about 0.2 to about 5, about 0.3 to about 4.0, or about 0.4 to about 3.5 times the average membrane thickness.

As shown in FIGS. 1 and 2 the manifold 100 is connected to a means, such as a variable-frequency/amplitude vibrator or oscillator 200, for displacing or vibrating membranes perpendicular to the direction of disperse phase flow through the membrane pores. As described previously the disperse phase is directed into the membrane 140 through feed holes 124 by means of pressure, for example a pulseless pump (i.e., syringe or gear pump) or under pressure from the pressurized disperse phase tank to form a plurality of droplets. In some embodiments, the disperse phase comprises a polymer precursor which can be subsequently solidified.

In embodiments, a shear force provided by oscillatory motion is provided across the membrane at a point of entry of the disperse phase into the continuous phase. In embodiments, the membrane can mechanically move in one or more directions. For example, the membrane can be harmonically moved along any line within the plane of the membrane. Without being bound by theory, the shear force is thought to interrupt the disperse phase flow through the membrane creating droplets. In embodiments, the shear force may be provided by rapidly displacing the membrane by vibrating, pulsing or oscillating movement. In embodiments, the membrane can be moved in a direction perpendicular to the exiting direction of the disperse phase from the membrane.

In embodiments the oscillation frequency for the present invention can range from about 5 Hz to about 100 Hz, or about 10 Hz to about 100 Hz, or about 10 Hz to about 60 Hz. For example, the frequency can be about 5 Hz, 10 Hz, 15 Hz, 20 Hz, 25 Hz, 30 Hz, 35 Hz, 40 Hz, 45 Hz, 50 Hz, 60 Hz, 70 Hz, 80 Hz, or 90 Hz. In embodiments suitable amplitude of movement values are in the range of about 0.1 mm to about 30 mm, or about 1 mm to about 20 mm, or about 1 mm to about 10 mm. For example, the membrane can have an amplitude of movement of about 0.1 mm, 0.5 mm, 1 mm, 2 mm, 3 mm, 4 mm, 5 mm, 6 mm, 7 mm, 8 mm, 9 mm, 10 mm, 15 mm, 20 mm, 25 mm, or 30 mm.

In embodiments the oscillatory motion can be generated by means of a cam follower that is mounted offset to the axis of the main drive shaft (scotch yoke). This offset provides the amplitude of the oscillation i.e. 1 mm offset=2 mm of displacement. The present invention allows for a range of displacement from 0 mm to about 40 mm, from about 2 mm to about 40 mm, or from about 2 mm to about 20 mm. As the shaft rotates the yoke is restrained to only move in the plane which is at right angles to the axis of the drive shaft will move along this plane in an oscillatory motion in time with the rotation of the main drive. Both the yoke and the cam follower are designed to withstand the forces generated by the oscillation. The motion provided by this scotch yoke forms a simple harmonic curve, but with modification to the servo drive to provide camming to the servo could create any number of motion profiles, including trapizoidal or polynomial profiles.

In embodiments a motor may be used, such as an Allen Bradley MPL-B540 servo motor (Rockwell Automation, Milwaukee, Wis.) which has a maximum speed of 4000 rpm (67 Hz of oscillation frequency) and its max torque of 14.9 NM.

Membrane 140 in FIG. 5 may be composed of any material capable of having a plurality of pores that are suitable for injecting a liquid disperse phase into a continuous phase. the membrane can be made of metal, ceramic material, silicon or silicon oxide, polymeric material, woven mesh material, or any combination thereof. Membranes containing a metal can be used. In embodiments, the membrane is substantially metallic, or wholly metallic. According to another embodiment, the membrane is a chemically-resistant metal such as nickel or steel. In yet another embodiment, the metallic membrane is pretreated with a chemical reagent (e.g., sodium hydroxide and/or an inorganic acid) to remove surface oxide layers. In still yet another embodiment the membrane made me made from a non-metallic material, such as a film material—for example Kapton®

In still yet another embodiment the membrane may be made from a woven mesh material, such as a nylon woven mesh—for example Sefar Nitex® (Sefar A G, Heiden, Switzerland). The membrane pores may be derived from the openings in the mesh material. The size and density of openings in a mesh material is determined by mesh count. Mesh count is the number of openings per square inch of material. The opening area (aperture) is generally square or rectangular in shape and can vary in size depending on the fiber diameter. Approximate mesh & corresponding aperture sizes are shown below in TABLE 1.

TABLE 1

| Mesh | Pore Size (Aperture) - diameter (um) |
|---|---|
| 400 | 23 |
| 500 | 19 |
| 600 | 16 |
| 800 | 12 |
| 1000 | 9 |
| 1200 | 6 |

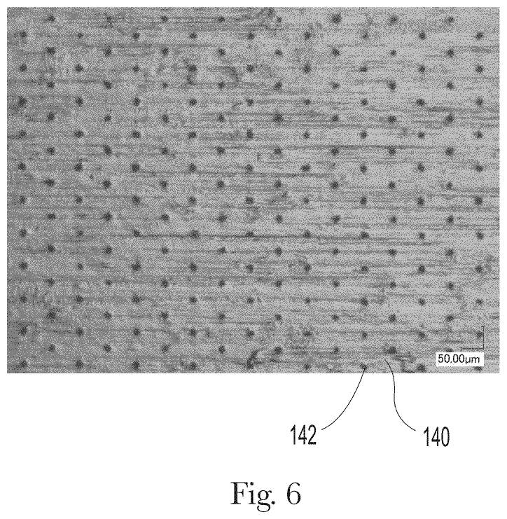

Referring to FIG. 6-8, in embodiments, the membrane 140 has a plurality of pores 142. The pores can have any suitable size, density, and arrangement on the membrane outer 148 (surface intended to face continuous phase) or inner surface 146 (surface intended to face dispersed phase). According to the present invention pore density (number of pores per mm²) can be determined by a number of factors, such as desired particles size, desired droplet size, chemistry of the monomer, material of membrane, cross-sectional shape and length of the pore, desired throughput, prevention of droplet coalescence, etc. In embodiments, the pores on the membrane outer surface 148, which are intended to face the outer compartment 82, can have an average diameter of about 0.1 μm to about 50 μm, or about 0.1 μm to about 35 μm, or about 0.5 μm to about 30 μm, or about 0.5 μm to about 20 μm, or about 1 μm to about 20 μm, about 4 μm to about 20 μm, or about 1 μm to about 10 μm. For example, the plurality of pores in the membrane can have an average diameter of about 0.10.5, 1, 2, 3, 4, 5, 6, 7, 8, 9, 10, 15, 20, 25, 30, 35, 40, 45, 50 μm. The plurality of pores can be dispersed randomly across the surface of the membrane or can be arranged in a designated pattern covering the membrane surface. For example, the membrane can include a plurality of pores in a circular, rectangular, square, triangular, pentagonal, hexagonal, or octagonal array.

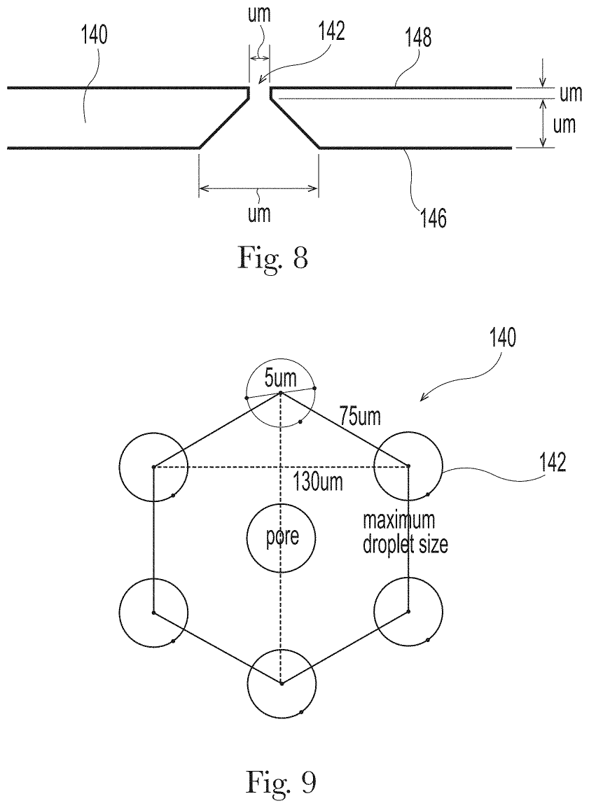

The membrane may have a pore density from about 10 pores/mm² to about 1000 pores/mm², from about 15 pores/mm² to about 900 pores/mm², from about 20 pores/mm² to about 800 pores/mm² pores throughout its surface. The shape of the membrane pores may vary. For example, the shape of the pores can be cylindrical or conical. Generally, pore diameter is a function of membrane thickness, such that the membrane thickness to pore diameter is in the range of 30:1, 20:1 or 15:1 depending on the type of material used for the membrane, shape of the pore, and technique used to form the pores. FIG. 8 is a schematic illustrating a conical-shaped membrane pore 142 of the invention.

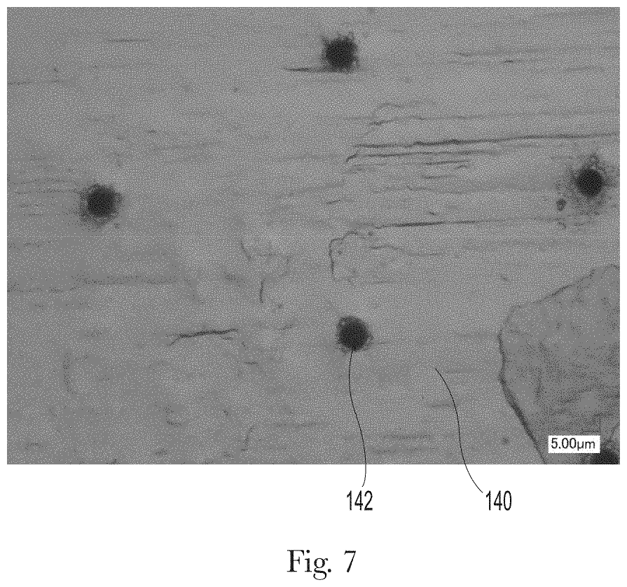

FIG. 7 is a micrographic image of a membrane 140 of the present invention. In this embodiment, the membrane is composed of steel and contains a plurality of 7 μm pores 142.

The example membrane pattern illustrated in FIG. 9 includes a pore diameter of 5 μm, with 75 μm spacing between adjacent pores as measured by the distance between the centers of the adjacent pores. The example of FIG. 9 illustrates a hexagonal array. Any suitable membranes can be used including commercially available membranes. TABLE 2 below provides some example membrane features that can be used in embodiments of the disclosure.

TABLE 2

| Pore Size | Distance between | Open | |
|---|---|---|---|
| (dₚ, μm) | pores (L, μm) | Area (%) | L/dₚ^{*} |
| 5 | 75 | 0.4 | 15 |
| 7 | 40 | 2.8 | 5.7 |
| 4.64 | 75 | 0.35 | 16.2 |
| 2.5 | 40 | 0.35 | 16 |
| 17.6 | 75 | 5 | 4.3 |
| 9.4 | 40 | 5 | 4.3 |

*L/dₚ is the distance between the pores divided by the diameter of the pores
In FIG. 9 the open area percentage can be calculated as:
$Open Area Percentage = \frac{Open Area}{Total Area *} = \frac{2 \times pore cross section}{Total Area *} = \frac{2 ( π / 4 ) {( dp )}^{2}}{Total Area *}$ * where the total area calculation is dependent on the shape of the membrane.

In embodiments, the open area percentage can be calculated using a rectangular subsection of the membrane, assuming regular spacing and sizing of the pores across the remaining surface of the membrane. In such embodiments the cross section of the pores within the rectangle is used and the total area is represented by the area of the rectangle. Using FIG. 9 as an Example, the open area % can be calculated as such:

Open Area=(2×pore cross section)=2(π/4)(dₚ)=77 μm [wherein dₚ=7 μm] Total area=(L=)75 μm×(√3*L=)130 μm=9750 μm [area of the rectangle shown in FIG. 9] % Open area=open area/total area=0.8%

In embodiments, adjacent pores of the plurality of pores in the membrane can be spaced an average distance between the center of each pore of about 5 μm to about 500 μm, or about 10 μm to about 250 μm, or about 10 μm to about 200 μm. For example, the plurality of pores in the membrane can have a distance between the center of each pore of about 5 μm, 10 μm, 20 μm, 30 μm, 40 μm, 50 μm, 60 μm, 70 μm, 75 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, or 250 μm.

In embodiments, the side of the membrane facing the continuous phase can have an open area of about 0.01% to about 20% of the surface area of the membrane side, or about 0.1% to about 10%, or about 0.2% to about 10%, or about 0.3% to about 5%. For example, the membrane has an open area of about 0.1%, 0.2%, 0.3%, 0.4%, 0.5%, 0.6%, 0.7%, 0.8%, 0.9%, 1%, 2%, 3%, 4%, 5%, 6%, 7% or 8%, or the surface area of the membrane side.

In embodiments, the dispersed phase can be passed through the plurality of pores in the membrane at a flux of about 1 m³/m²h to about 500 m³/m²h, or about 1 m³/m²h to about 300 m³/m²h, or about 2 m³/m²h to about 200 m³/m²h, or about 5 m³/m²h to about 150 m³/m²h, 5 m³/m²h to about 100 m³/m²h For example, the dispersed phase can be passed through the plurality of pores in the membrane at a flux rate of 1 m³/m²h, 2 m³/m²h, 3 m³/m²h, 4 m³/m²h, 5 m³/m²h, 6 m³/m²h, 7 m³/m²h, 8 m³/m²h, 9 m³/m²h, 10 m³/m²h, 20 m³/m²h, 30 m³/m²h, 40 m³/m²h, 50 m³/m²h, 60 m³/m²h, 70 m³/m²h, 80 m³/m²h, 90 m³/m²h, 100 m³/m²h, 150 m³/m²h, 200 m³/m²h, 250 m³/m²h, 300 m³/m²h, 350 m³/m²h, 400 m³/m²h, 450 m³/m²h, or 500 m³/m²h. As described herein, the flux is calculated by the following equation:

$$FLUX ( \frac{{m}^{3}}{{m}^{2} h} ) = \frac{Flow Rate Disperse Phase ( \frac{m 3}{h} )}{Open Area of Membrane ( m2 )} = \frac{Flow Rate Disperse Phase [ \frac{{m}^{3}}{h} ]}{( \# pores ) * \frac{π}{4} {D}_{pores}^{2} [ {m}^{2} ]}$$

wherein, D is the diameter of the pores in the membrane.

The flow rate of the continuous phase can be adjusted in combination with the flow rate of the dispersed phase to achieve a desired concentration of dispersed phase in the continuous phase.

It has been advantageously found that the concentration of dispersed phase in the continuous phase by weight can controlled as a function of the flow rate of the dispersed phase through the plurality of pores in the membrane and the flow rate of the continuous phase across the outer surface of the membrane. Advantageously, methods of the disclosure can allow for fine control of the concentration of the dispersed phase in the continuous phase. This can beneficially allow high concentrations of dispersed phase to be incorporated into the continuous phase with the control necessary to prevent overloading of the continuous phase and avoid concentrations at which the droplets of dispersed phase start to coalesce. In embodiments, the ratio of the continuous phase flow rate to dispersed phase flow rate can be 0.1:1, 0.5:1, 1:1, 1.2:1, 1.5:1, 1.8:1, 2:1, 2.5:1, 3:1, 4:1, or 5:1. Selection of the stabilizer system, as described above, can also allow for prevention or limiting of coalescence of the droplets while allowing high concentrations of dispersed phase in the continuous phase. This is advantageous to maintaining narrow particle size distributions while obtaining high concentrated emulsions.

In accordance with embodiments, the concentration of dispersed phase in the continuous phase can be about 1% to about 70%, or about 5% to about 60%, or about 20% to about 60%, or about 30% to about 60%, or about 40% to about 60%. Advantageously, the method herein can have a concentration of dispersed phase in the continuous phase of about 30% or more, for example, about 1%, 5%, 10%, 15%, 20%, 25%, 30%, 35%, 40%, 45%, 50%, 55% or 60%. In embodiments, concentrations of dispersed phase in continuous phase can be up to about 60%, while maintaining limited coalescence, such that the number population diameter CoV in the emulsion is less than or equal to 100%. In embodiments, the resulting emulsion can have a concentration of dispersed phase in the continuous phase greater than or equal to 40%, or greater than or equal to 50%, while maintaining a number population diameter CoV in the emulsion of less than or equal to 100%. In embodiments, a high concentration of dispersed phase in the continuous phase can be achieved by having the following: (1) a high flux of dispersed phase through the membrane, (2) a tuned stabilizer system, and (3) high shear stress at the membrane surface.

Having high flux of dispersed phase in the membrane can be advantageous to achieving a high concentration of dispersed phase in the continuous phase, because the higher the velocity of the dispersed phase, the more dispersed phase reaches the surface of the membrane, increasing the amount of oil that is emulsified, and therefore increasing the overall concentration of dispersed phase in continuous phase. Having a tuned stabilizer system can be advantageous because the stabilizer system can stabilize the droplets of dispersed phase and lower the rate of coalescence of the dispersed phase droplets and increase mass transfer rate. Increasing mass transfer rate can be favorable to avoid coalescence and achieve a narrow size distribution as fresh molecules of the stabilizer system have to reach the surface of the membrane while they are forming Increasing mass transfer rate can help the transportation of dispersed phase droplets away from the membrane surface where new droplets are being formed in order to avoid further coalescence and decrease the local concentration of dispersed phase near the membrane. However, having a high concentration of stabilizer system in the emulsion increases the viscosity of the emulsion. Having an increased viscosity of the emulsion can slow the mass transfer of stabilizer molecules as well as the dispersed phase through the continuous phase leading to higher rate of coalescence of the dispersed phase. The stabilizer system therefore needs to be tuned to have enough concentration in the emulsion to achieve the advantages while not negatively effecting the emulsion by increasing viscosity too much. Having high shear stress at the membrane surface can be advantageous because the increased shear stress reduces the size of the droplets of dispersed phase, which favors the movement of said droplets of dispersed phase from the membrane surface.

In embodiments, TABLE 3 shows the minimum and maximum values as it pertains to the concentration of dispersed phase in the continuous phase. The T can be calculated with the following equation:

$$\frac{{τ}_{max}}{{( 2 * ρ μ )}^{0.5}} = 2 {a ( π f )}^{1.5}$$

Where:
τₘₐₓ is the peak shear event during the oscillation (max shear stress)
ρ—density of continuous phase
μ—viscosity of continuous phase
a—amplitude of oscillation
f—frequency of oscillation

TABLE 3

| | Disperse Phase Flux (m³/(m²h)) | Viscosity of stabilizer solution (cPs)** | $\begin{matrix}Specific Shear Stress \\ [ \frac{{τ}_{max}}{{( 2 * ρ μ )}^{0.5}} , m {s}^{- 1.5} ]\end{matrix}$ |
|---|---|---|---|
| Min Value | 14.3 | 1 | 0.63 |
| Max Value | 120 | 120 | 23 |

The membrane pores may be fabricated by any conventional method. For example, the membrane pores may be fabricated by drilling, laser treating, electro-formed, or water jetting the membrane. The membrane pores are preferably electro-formed by electroplating or electroless plating of nickel on a suitable mandrel. In another embodiment, the membrane pores are perpendicular to the surface. In another embodiment, the membrane pores are positioned at an angle, preferably at an angle from 40° to 50°. In embodiments, the overall average thickness of the membrane is in the range of about 1 μm to about 1000 μm, or about 5 μm to about 500 μm, or about 10 μm to about 500 μm, or about 20 μm to about 200 μm. For example, the membrane can have a thickness of about 10 μm, 15 μm, 20 μm, 25 μm, 30 μm, 40 μm, 50 μm, 60 μm, 70 μm, 80 μm, 90 μm, 100 μm, 110 μm, 120 μm, 130 μm, 140 μm, 150 μm, or 200 μm.

In certain embodiments the particles described herein may be capsules, in that they have a polymeric shell surrounding a core. Capsules in accordance with embodiments of the disclosure can include a benefit agent. In embodiments, the capsules can be incorporated into a formulated product for release of the benefit agent upon capsule rupture. Various formulated products having capsules are known in the art and capsules in accordance with the disclosure can be used in any such products. Examples include, but are not limited to, laundry detergent, hand soap, cleaning products, lotions, Fabric enhancers, beauty care products, skin care products and other cosmetic products.

In various embodiments, capsules are produced having a narrow particle size distribution. In various embodiments, capsules have a delta fracture strength percentage, as discussed in more detail below, of 15% to 230% and a shell thickness of about 20 nm to about 400 nm. In various embodiments, the capsules may have an average diameter of greater than 1 μm. In embodiments, each of the capsules has a diameter greater than 1 μm. In various embodiments, the capsules have a coefficient of diameter variation (by number %) of between 10% and 100%, and average ratio of the volume percent of core material to the volume percent of shell material of greater than or equal to about 95:5. In embodiments, the capsules have an average shell thickness of 20 nm to 300 nm. In embodiments, a capsule has an average volume percent of core material to volume percent of shell material of greater than about 95:5.

In embodiments, the population of capsules can include a delta fracture strength percentage in the range of about 15% to about 230% and a shell thickness of 20 nm to 400 nm. In embodiments, the population of capsules can include a number population diameter coefficient of variation of 10% to 100%, a shell thickness of 20 nm to 400 nm, and an average ratio of volume percent based on the total volume of the capsule of core material to shell material is greater than or equal to about 90:10.

The foregoing represents example embodiments of combinations of capsule properties. These and various additional properties are further described in detail below. It should be understood herein that other combinations of such properties are contemplated herein and can be any one or more of such properties described in the following paragraphs can be used in various combinations.

In various embodiments, a capsule is provided as a single capsule, as part of a population of capsules, or as a part of a plurality of capsules in any suitable number. Reference to individual capsule features, parameters and properties made herein shall be understood to apply to a plurality of capsules or population of capsules. It should be understood herein that such features and associated values can be mean or average values for a plurality or population of capsules, unless otherwise specified herein.

In any of the embodiments herein, the core can include a benefit agent. In various embodiments, the core can be liquid.

In embodiments, a capsule or a population of capsules can have an average ratio of the volume percent based on the total volume of the capsule of core material to shell material of at least 80 to 20, 85 to 15, 90 to 10, 95 to 5, 98 to 2, 99 to 1, 99.9 to 0.1, or 99.99 to 0.01. For example, a capsule or a population of capsules can have an average ratio of the volume percent based on the total volume of the capsules of core material to shell material of 80 to 20, 85 to 15, 90 to 10, 95 to 5, 98 to 2, 99 to 1, 99.9 to 0.1, or 99.99 to 0.01. In embodiments, the population of capsules can have an average ratio of the volume percent based on the total volume of the capsule of core material to shell material of about 80 to 20 to about 99.9 to 0.1, or about 90 to 10 to about 99.9 to 0.1, or about 95 to 5 to about 99.99 to 0.01, or about 98 to 2 to about 99.99 to 0.01. In embodiments, the entire population of capsules can have an average ratio of the volume percent based on the total volume of the capsule of core material to shell material of at least 80 to 20, or at least 90 to 10 or at least 95 to 5, or at least 98 to 2. High core to shell material ratios can advantageously result in highly efficient capsules having a high content of benefit agent per capsule. This can, in embodiments, allow for high loading of benefit agent in a formulated product having the capsules and/or allow for lower amounts of capsules to be used in a formulated product.

In embodiments, capsules or a population of capsules can have a delta fracture strength percentage of about 10% to about 500%, or about 10% to about 350%, or about 10% to about 230%, about 15% to about 350%, about 15% to about 230%, about 50% about 350%, about 50% to about 230%, about 15% to about 200%, about 30% to about 200%. For example, the population of capsules can have a delta fracture strength percentage of about 10%, 15%, 20%, 25%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 300%, 350%, 400%, or 500%. The delta fracture strength percentage can be calculated using the following equation:

$$Delta Fracture Strength ( \% ) = \frac{FS @ {d}_{5} - FS @ {d}_{90}}{FS @ {d}_{50}} * 100$$

wherein the FS stands for fracture strength and FS at dᵢ is the FS of the capsules at the percentile “i” of the volume size distribution. The fracture strength can be measured by the Fracture Strength Test Method further described below.

Delta fracture strength percentages in the range of 15% to 230% can be advantageous for ensure proper and more uniform capsule release of a benefit agent in a formulated product at the desired time. For example, in embodiments the formulated product can be a laundry detergent and capsules having delta fracture strength percentages in the range of 15% to 230% can beneficially ensure that substantially all the capsules release the benefit agent at the targeted phase of the wash cycle.

In embodiments, the capsules can have a diameter of greater than 1 μm. In embodiments, capsules or a population of capsules can have a mean diameter of greater than 1 μm. In embodiments, capsules or a population of capsules can have a median diameter of greater than 1 μm. In any of the forgoing embodiments, the referenced diameter can be greater than or equal to 1 μm, 2 μm, 3 μm, 4 μm, 5 μm, 10 μm, 15 μm, 20 μm, or 25 μm. In any of the foregoing embodiments, the referenced diameter can be about 1 μm to 100 μm, or 1 μm to 80 μm, or 1 μm to 65 μm, or 1 μm to 50 μm, or 5 μm to 80 μm, or 10 μm to 80 μm, or 10 μm to 65 μm, or 15 μm to 65 μm, or 20 μm to 50 μm. For example, the referenced diameter can be about 1 μm, 2 μm, 3 μm, 4 μm, 5 μm, 10 μm, 15 μm, 20 μm, 25 μm, 30 μm, 35 μm, 40 μm, 50 μm, 55 μm, 60 μm, 65 μm, 70 μm, 75 μm, 80 μm, 85 μm, 90 μm, 95 μm, or 100 μm. In embodiments, the entire population of capsules can have a diameter of greater than 1 μm, 2 μm, 3 μm, 4 μm, 5 μm, or 10 μm. In embodiments, the entire population of capsules can include a diameter of 1 μm to 80 μm, 3 μm to 80 μm, or 5 μm to 50 μm, or 10 μm to 50 μm.

In embodiments, the capsules can have coefficient of diameter variation based on volume percent of less than 50%, or less than 45%, or less than 40%, or less than 35%, or less than 30%, or less than 25%, or less than 20%. For example, the diameter CoV based on volume percent of about 20% to about 50%, or about 25% to about 40%, or about 20% to about 45%, or about 30% to about 40%. The diameter CoV based on volume (CoVv) percent is calculated from the following equation:

$$CoVv ( \% ) = \frac{{σ}_{v}}{{μ}_{v}} * 100$$

$$wherein , \\ {σ}_{v} = {( {\sum }_{i = 1 um}^{493.3 um} ( {x}_{i , v} * {( {d}_{i} - {μ}_{v} )}^{2} ) )}^{0.5}$$

$${μ}_{v} = \frac{{\sum }_{i = 1 um}^{493.3 um} ( {x}_{i , v} * {d}_{i} )}{{\sum }_{i = 1 um}^{493.3 um} {x}_{i , v}} .$$

The equation terms are as follows:
σᵥ—Standard deviation of distribution of volume distribution
μᵥ—mean of the distribution of volume distribution
dᵢ—diameter in fraction i (>1 μm)
x_{i,v}—frequency in fraction i (corresponding to diameter i) of volume distribution

In embodiments, the capsules can have a diameter coefficient variation based on number percent of about 1% to about 150%, or about 1% to about 100%, or about 10% to about 100%, or about 10% to about 80%, or about 10% to about 50%. For example, the capsules can have diameter coefficient variation based on number percent of about 1%, 5%, 10%, 15%, 20%, 25%, 30%, 35%, 40%, 45%, 50%, 60%, 70%, 80%, 90%, 100%, or 150%. The number population diameter coefficient variation (CoVn) can be calculated by the following equation:

### Wherein:

$${σ}_{n} = {( {\sum }_{i = 1 um}^{493.3 um} ( {x}_{i , n} * {( {d}_{i} - {μ}_{n} )}^{2} ) )}^{0.5}$$

$${μ}_{n} = \frac{{\sum }_{i = 1 um}^{493.3 um} ( {x}_{i , n} * {d}_{i} )}{{\sum }_{i = 1 um}^{493.3 um} {x}_{i , n}}$$

### Where:

σₙ—Standard deviation of distribution of number distribution
μₙ—mean of the distribution of number distribution
dᵢ—diameter in fraction i (>1 μm)
x_{i,n}—frequency in fraction i (corresponding to diameter i) of number distribution

$${x}_{i , n} = \frac{{n}_{i}}{{\sum }_{i = 1 um}^{493.3 um} {n}_{i}}$$

The relationship between number and volume distribution is represented by the following equation:

$${x}_{i , v} = \frac{{x}_{i , n} * {d}_{i}^{3}}{{\sum }_{i = 1 um}^{493.3 um} ( {x}_{i , n} * {d}_{i}^{3} )}$$

### Core

In any of the embodiments disclosed herein, the capsules can include a benefit agent in the core. In embodiments, the benefit agent can include one or more perfumes, brighteners, insect repellants, silicones, waxes, flavors, vitamins, fabric softening agents, skin care agents, UV blocker, enzymes, probiotics, dye polymer conjugate, dye clay conjugate, perfume delivery system, sensates, cooling agent, attractants, pheromones, anti-bacterial agents, dyes, pigments, bleaches, and disinfecting agents. In embodiments, the benefit agent can include a perfume or perfume delivery system.

In embodiments, the benefit agent can be present in about 45 wt % or more based on the total weight of the core. In embodiments, the benefit agent is a perfume or perfume delivery system and in embodiments the perfume is present in about 45 wt % or more based on the total weight of the core. In embodiments, the capsules can include the benefit agent in about 45 wt % or more, or 50 wt % or more, or 60 wt % or more, or 70 wt % or more, or 80 wt % or more, or 90 wt % or more, based on the total weight of the core.

In embodiments, the benefit agent can have a Clog P value of greater than or equal to 1. In embodiments, the benefit agent can have a Clog P value of 1 to 5, or 1 to 4, or 1 to 3 or 1 to 2. For example, the benefit agent can have a Clog P value of about 1, 1.5, 2, 2.5, 3, 3.5, 4, 4.5 or 5.

In embodiments, the core can further include additional components such as excipients, carriers, diluents, and other agents. In embodiments, the benefit agent can be admixed with an oil. Non-limiting examples of oils include isopropyl myristate, mono-, di-, and tri-esters of C₄-C₂₄ fatty acids, castor oil, mineral oil, soybean oil, hexadecanoic acid, methyl ester isododecane, isoparaffin oil, polydimethylsiloxane, brominated vegetable oil, and combinations thereof. Capsules may also have varying ratios of the oil to the benefit agent so as to make different populations of microcapsules that may have different bloom patterns. Such populations may also incorporate different perfume oils so as to make populations of capsules that display different bloom patterns and different scent experiences. US 2011-0268802 discloses other non-limiting examples of oils and is hereby incorporated by reference. In embodiments, the oil admixed with the benefit agent can include isopropyl myristate.

### Shell

In any of the embodiments disclosed herein, the capsule shell can be a polymeric shell and can include greater than 90% polymeric material, or greater than 95% polymeric material, or greater than 98% polymeric material or greater than 99% polymeric material. In embodiments, the polymeric shell can include one or more of a homopolymer, a copolymer, and a crosslinked polymer. In embodiments, the polymeric shell can include a copolymer and a crosslinked polymer. In embodiments, the polymeric shell can be made from simple and/or complex coacervation. In embodiments, the polymeric shell can include one or more of polyacrylate, polymethacrylate, melamine formaldehyde, polyurea, polyurethane, polyamide, polyvinyl alcohol, chitosan, gelatin, polysaccharides, or gums. In embodiments, the polymeric shell comprises poly(meth)acrylate. As used herein, the term “poly(meth)acrylate” can be polyacrylate, polymethacrylate, or a combination thereof.

In embodiments, the capsules can have a shell thickness or an average shell thickness of about 1 nm to about 1000 nm, or about 1 nm to about 800 nm, or about 1 nm to about 500 nm, or about 5 nm to about 500 nm, or about 5 nm to about 400 nm, or about 10 nm to about 500 nm, or about 10 nm to about 400 nm, or about 20 nm to about 500 nm, or about 20 nm to about 400 nm, or about 50 nm to about 400 nm, or about 50 nm to about 350 nm. For example, the shell thickness or average shell thickness can be about 1 nm, 5 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 450 nm, 500 nm, 600 nm, 700 nm, 800 nm, 900 nm, or 1000 nm. In embodiments, the entire population of capsules can have a shell thickness of less than 1000 nm, or less than 800 nm, or less than 600 nm, or less than 400 nm, or less than 350 nm.

In various embodiments, capsules and methods of making capsules allow for reduced shell thickness. For example, capsules can have thickness of about 20 nm to about 400 nm. In various embodiments, capsules having a shell thickness of about 20 nm to about 400 nm can maintain sufficient fracture strength and a desired release profile to remain functional for a formulated product. For example, in such embodiments, capsules can have a median fracture strength of about 1 MPa to about 14 MPa. In such embodiments, the reduced shell thickness as compared to conventional capsules can beneficially allow for reduced amount of polymeric precursor material being required, which can reduced cost and can reduced environmental impact

In embodiments, capsules can have a delta fracture strength of about 15% to about 230%, and a shell thickness of about 20 nm to about 400 nm. Such combination can be advantageous, allowing uniform and timely release in a formulated product, while reducing the polymeric material needed.

In embodiments, the capsules can have a coefficient of diameter variation as measured by number percent of about 10% to about 100%, an average shell thickness in the range of about 20 nim to about 400 nm, and an average ratio of volume percent based on the total volume of the capsule of core material to shell material is greater than or equal to about 95 to 5.

### Method of Making

In accordance with embodiments, methods of making capsules having a core surrounded by a polymeric shell can include use of membrane emulsification. In various embodiments, methods of making capsules can include dispersing droplets of a dispersed phase in a continuous phase by passing the dispersed phase through a plurality of pores in a membrane. In embodiments, the method can include passing the dispersed phase through the membrane, from an inner surface of the membrane to an outer surface of the membrane, into a continuous phase flowing across the outer surface of the membrane. Upon exiting the plurality of pores on the outer surface of the membrane, the dispersed phase is formed into droplets of dispersed phase. In embodiments, the membrane can be mechanically moved while the dispersed phase is passed through the membrane to generate shear force on the outer surface of the membrane to exit the membrane and disperse into the flowing continuous phase.

In embodiments, the dispersed phase can include a polymer precursor and a benefit agent. In embodiments, the method can further include subjecting the emulsion of dispersed phase in continuous phase to conditions sufficient to initialize polymerization of a polymer precursor within the droplets of dispersed phase. Selection of suitable polymerization conditions can be made as is known it the art for a particular polymer precursors present in the dispersed phase. Without intending to be bound by theory, it is believed that upon initialization of the polymerization, the polymer becomes insoluble in the dispersed phase and migrates within the droplet to the interface between the dispersed phase and the continuous phase, thereby defining the capsules shell.

In embodiments, the method can form capsules using an inside-out polymerization method in which dispersed phase droplets include a soluble polymer precursor that becomes insoluble upon polymerization\migrates to the interface between the dispersed phase and the continuous phase to thereby form the capsule shell surrounding the core, which includes the remaining components of the dispersed phase, such as a benefit agent, upon full polymerization.

In embodiments, the dispersed phase can include one or more of a polymer precursor, an anti-solvent, and a benefit agent. In embodiments, the polymer precursor can include one or more monomers and oligomers, including mixtures of monomers and oligomers. In embodiments, the polymer precursor is soluble in the dispersed phase. In embodiments, the polymer precursor is multifunctional. As used herein, the term “multifunctional” refers to having more than one reactive chemical functional groups. For example, a reactive chemical functional group F can be a carbon-carbon double bond (i.e. ethylenic unsaturation) or a carboxylic acid. In embodiments, the polymer precursor can have any desired number of functional groups F. For example, the polymer precursor can include two, three, four, five, six, seven, eight, nine, ten, eleven, or twelve functional groups F).

In embodiments, the polymer precursor can include an ethylenically unsaturated monomer or precursor. In embodiments, the polymer precursor can include amine monomers selected from the group consisting of aminoalkyl acrylates, alkyl aminoalkyl acrylates, dialkyl aminoalykl acrylates, aminoalkyl methacrylates, alkylamino aminoalkyl methacrylates, dialkyl aminoalykl methacrylates, tertiarybutyl aminethyl methacrylates, diethylaminoethyl methacrylates, dimethylaminoethyl methacrylates, dipropylaminoethyl methacrylates, and mixtures thereof; and a plurality of multifunctional monomers or multifunctional oligomers. In embodiments, the polymer precursor can include one or more acrylate ester. For example, the polymer precursor can include one or more of methacrylate, ethyl acrylate, propyl acrylate, and butyl acrylate. In embodiments, the polymer precursor is one or more ethylenically unsaturated monomers or oligomer. In various embodiments, the ethylenically unsaturated monomer or oligomer is multifunctional. In embodiments, the multifunctional ethylenically unsaturated monomer or oligomer is a multifunctional ethylenically unsaturated (meth)acrylate monomer or oligomer. In embodiments, the multifunctional ethylenically unsaturated monomer or oligomer can include two, three, four, five, six, seven, eight, nine, ten, eleven, or twelve functional groups F. In embodiments, the multifunctional ethylenically unsaturated monomer or oligomer can include at least three functional groups. In embodiments, the multifunctional ethylenically unsaturated monomer or oligomer can include at least four functionalities. In embodiments, the multifunctional ethylenically unsaturated monomer or oligomer can include at least five functional groups.

These oligomeric materials with multiple functionalities enable crosslinking of the polymeric backbones allowing formation of a shell wall through insolubility and polymer precipitation at the oil water interface. The crosslinking also provides rigidity and durability of the shell wall. In embodiments, the polymer precursor can include one or more of a polyacrylate, acrylate, polymethacrylate, methacrylate, melamine formaldehyde, polyurea, urea, polyurethane, polyamide, amide, polyvinyl alcohol, chitosan, gelatin, polysaccharide, and gum. In embodiments, the polymer precursor can include a polyacrylate precursor. In embodiments, the polymer precursor can include a polyacrylate or polymethacrylate precursor with at least three functionalities. For example, the polymer precursor can be a compound of formula I.

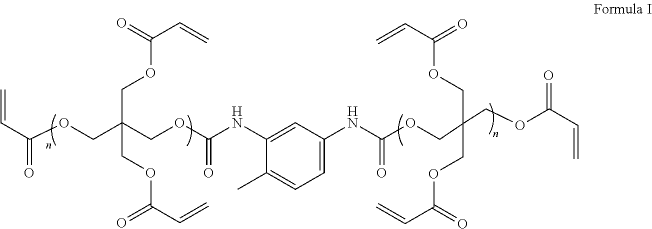

In embodiments, the polymer precursor can include one or more of hexafunctional aromatic urethane-acrylate oligomer, tertiarybutylaminoethyl methacrylate, 2-carboxyethyl acrylate, pentaerythritol triacrylate, pentaerythritol tetraacrylate, di(trimethylolpropane) tetraacrylate, propoxylated trimethylpropane triacrylate, dipentaerythritol pentaacrylate, tri(2-hydroxy ethyl) isocyanurate triacrylate,

In embodiments, the polymer precursor can be present in the dispersed phase in an amount of about 0.01 wt % to about 30 wt % based on the total weight of the dispersed phase, or about 0.01 wt % to about 20 wt %, or about 0.05 wt % to about 20 wt %, or about 0.1 wt % to about 15 wt %, or about 0.5 wt % to about 15 wt %, or about 1 wt % to about 15 wt %, or about 5 wt % to about 15 wt %, or about 0.05 wt % to about 15 wt % based on the total weight of the dispersed phase. For example, the polymer precursor can be present in about 0.01 wt %, 0.05 wt %, 0.1 wt %, 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt %, based on the total weight of the dispersed phase.

In embodiments, the continuous phase can be free or substantially free of polymer precursor. As used herein, the term “substantially free of polymer precursor” means that the continuous phase contains 0.0001 wt % or less of the polymer precursor.

In embodiments, the polymer precursor included in the dispersed phase is polymerized into the polymer that makes up about 98 wt % or more of the shell. In embodiments, the shell can include about 99 wt % or more polymer that was polymerized from the polymer precursor originating in the dispersed phase. In embodiments, the shell can include about 99.9 wt % or more polymer that was polymerized from the polymer precursor originating in the dispersed phase

In embodiments, the method of making the capsules can include a stabilizer system in one or both of the dispersed phase and the continuous phase. In embodiments, the stabilizer system can be present in an amount of about 0.01 wt % to about 30 wt % based on the total weight of the continuous phase, or about 0.1 wt % to about 25 wt %, or about 0.5 wt % to about 20 wt %, or about 1 wt % to about 20 wt %, or about 0.5 wt % to about 10 wt % based on the total weight of the continuous phase. For example, the stabilizer system can be present in an amount of about 0.1 wt %, 0.2 wt %, 0.3 wt %, 0.4 wt %, 0.5 wt %, 1 wt %, 2 wt %, 3 wt %, 4 wt %, 5 wt %, 6 wt %, 7 wt %, 8 wt %, 9 wt %, or 10 wt %.

In embodiments, the stabilizer system can include a primary stabilizer present in the continuous phase. In embodiments, the primary stabilizer can be present in an amount of about 51 wt % to about 100 wt % based on the total weight of the stabilizer system. In embodiments, the primary stabilizer can include an amphiphilic non-ionic stabilizer that can be soluble or dispersible in the continuous phase. In embodiments, the primary stabilizer can include one or more of a polysaccharide, a pyrrolidone based polymer, naturally derived gums, polyalkylene glycol ether; condensation products of alkyl phenols, aliphatic alcohols, or fatty acids with alkylene oxide, ethoxylated alkyl phenols, ethoxylated arylphenols, ethoxylated polyaryl phenols, carboxylic esters solubilized with a polyol, polyvinyl alcohol, polyvinyl acetate, copolymers of polyvinyl alcohol and polyvinyl acetate, polyacrylamide, poly(N-isopropylacrylamide), poly(2-hydroxypropyl methacrylate), poly(2-ethyl-2-oxazoline), poly(2-isopropenyl-2-oxazoline-co-methyl methacrylate), poly(methyl vinyl ether), polyvinyl alcohol-co-ethylene, and acetatecyl modified polyvinyl alcohol. In embodiments, the primary stabilizer can include a polyvinyl alcohol. In embodiments, the polyvinyl alcohol can have a degree of hydrolysis of 50% to 99.9%. In embodiments, the polyvinyl alcohol can have a degree of hydrolysis of below 95%. In embodiments, the polyvinyl alcohol can have a degree of hydrolysis of 50% to 95%, or 50% to 95%, or 60% to 95%, or 70% to 95%, or 75% to 95%. For example, the degree of hydrolysis can be 50%, 55%, 60%, 65%, 70%, 75%, 80%, 85%, 90% or 95%. In embodiments, the polyvinyl alcohol can have a viscosity of 1 cP to 100 cP. Preferably 10 cP. In embodiments, the polyvinyl alcohol can have a molecular weight of X to Y.

In embodiments, selection of the stabilization system as described herein can beneficially aid in stabilization of the droplets at the membrane surface, which in turn can provide a more uniform droplet size, with a low coefficient of variation or particles size, a low delta fracture strength percentage. In embodiments, the primary stabilizer, such as polyvinyl alcohol, can be utilized to stabilize the emulsion at the interface between the dispersed phase droplets and the continuous phase and aid in preventing or reducing coalescence of the droplets. In embodiments, the stabilizer system can aid in providing an emulsion with a coefficient of diameter variation of droplet size of less than or equal to 40%.

In embodiments, the stabilizer system further includes one or more minor stabilizers. In embodiments, the stabilizer system includes minor stabilizers in an amount of about 49 wt % to about 0.1 wt % based on the total weight of the stabilizer system. For example, the minor stabilizer can be present in an amount of 1%, 2%, 3%, 4%, 5%, 10%, 20%, 30%, 40%, or 50%, of the total weight of the stabilizer system. In embodiments, the minor stabilizers can include a minor protective colloid present in the continuous phase. In embodiments, the minor protective colloid can include one or more of a low molecular weight surfactant, a cationic stabilizer, and an anionic stabilizer. In embodiments, the minor stabilizer can include a low molecular weight surfactant, wherein the low molecular weight surfactant can include one or more short chain EO/PO and an alkylsulfate.

The methods further include initializing polymerization of the monomers within the droplets of the dispersed phase. Various initiation methods can be used as are known in the art and selected based on the monomers to be polymerized. By way of example, initializing polymerization of the monomers can include methods involving one or more of a radical, thermal decomposition, photolysis, redox reactions, persulfates, ionizing radiation, electrolysis, or sonication. In embodiments, initializing polymerization of the polymer precursor can include heating the dispersion of droplets of dispersed phase in the continuous phase. In embodiments, initializing polymerization of the monomer can include exposing the dispersion of droplets of dispersed phase in the continuous phase to ultraviolet radiation. In embodiments, initializing polymerization can include activating an initiator present in one or both the dispersed phase and the continuous phase. In embodiments, the initiator can be one or more of thermally activated, photoactivated, redox activated, and electrochemically activated.

In embodiments, the initiator can include a free radical initiator, wherein the free radical initiator can be one or more of peroxy initiators, azo initiators, peroxides, and compounds such as 2,2′-azobismethylbutyronitrile, dibenzoyl peroxide. More particularly, and without limitation, the free radical initiator can be selected from the group of initiators comprising an azo or peroxy initiator, such as peroxide, dialkyl peroxide, alkylperoxide, peroxyester, peroxycarbonate, peroxyketone and peroxydicarbonate, 2,2′-azobis (isobutylnitrile), 2,2′-azobis(2,4-dimethylpentanenitrile), 2,2′-azobis (2,4-dimethylvaleronitrile), 2,2′-azobis(2-methylpropanenitrile), 2,2′-azobis(methylbutyronitrile), 1,1′-azobis (cyclohexanecarbonitrile), 1,1′-azobis(cyanocyclohexane), benzoyl peroxide, decanoyl peroxide; lauroyl peroxide; benzoyl peroxide, di(n-propyl)peroxydicarbonate, di(sec-butyl) peroxydicarbonate, di(2-ethylhexyl)peroxydicarbonate, 1,1-dimethyl-3-hydroxybutyl peroxyneodecanoate, a-cumyl peroxyneoheptanoate, t-amyl peroxyneodecanoate, t-butyl peroxyneodecanoate, t-amyl peroxypivalate, t-butyl peroxypivalate, 2,5-dimethyl 2,5-di (2-ethylhexanoyl peroxy)hexane, t-amyl peroxy-2-ethyl-hexanoate, t-butyl peroxy-2-ethylhexanoate, t-butyl peroxyacetate, di-t-amyl peroxyacetate, t-butyl peroxide, dit-amyl peroxide, 2,5-dimethyl-2,5-di-(t-butylperoxy)hexyne-3, cumene hydroperoxide, 1,1-di-(t-butylperoxy)-3,3,5-trimethyl-cyclohexane, 1,1-di-(t-butylperoxy)-cyclohexane, 1,1-di-(t-amylperoxy)-cyclohexane, ethyl-3,3-di-(t-butylperoxy)-butyrate, t-amyl perbenzoate, t-butyl perbenzoate, ethyl 3,3-di-(t-amylperoxy)-butyrate, and the like.

In embodiments, the initiator can include a thermal initiator. In embodiments, the thermal initiator can have a bond diassociation energy in the range of 100 kJ per mol to 170 kJ per mol. The thermal initiator can include one or more of peroxides, such as acyl peroxides, acetyl peroxides, and benzoyl peroxides, azo compounds, such as 2,2′-Azobisisobutyronitrile, 2,2′-azobis(2,4-dimethylpentanenitrile), 4,4′-azobis(4-cyanovaleric acid), and 1,1′-azobis(cylohexanecarbonitrile), and disulfides.

In embodiments, the initiator can include a redox initiator such as a combination of an inorganic reductant and an inorganic oxidant. For example, reductants such as peroxydisulfate, HSO₃⁻, SO₃²⁻, S₂O₃²⁻, S₂O₅²⁻, or an alcohol with a source of oxidant such as Fe²⁺, Ag⁺, Cu²⁺*, Fe³⁺, ClO₃⁻, H₂O₂, Ce⁴⁺, V⁵⁺, Cr⁶⁺, or Mn³⁺.

In embodiments, the initiator can include one or more photochemical initiators, such as benzophenone; acetophenone; benzil; benzaldehyde; o-chlorobenzaldehyde; xanthone; thioxanthone; 9,10-anthraquinone; 1-hydroxycyclohexyl phenyl ketone; 2,2-diethoxyacetophenone; dimethoxyphenylacetophenone; methyl diethanolamine; dimethylaminobenzoate; 2-hydroxy-2-methyl-1-phenylpropane-1-one; 2,2-di-sec-butoxyacetophenone; 2,2-dimethoxy-1,2-diphenylethan-1-one; dimethoxyketal; and phenyl glyoxal.2,2′-diethoxyacetophenone, hydroxycyclohexyl phenyl ketone, alpha-hydroxyketones, alpha-aminoketones, alpha and beta naphthyl carbonyl compounds, benzoin ethers such as benzoin methyl ether, benzil, benzil ketals such as benzil dimethyl ketal, acetophenone, fluorenone, 2-hydroxy-2-methyl-1-phenylpropan-one. UV initiators of this kind are available commercially, e.g., Irgacure 184, Irgacure 369, Irgacure LEX 201, Irgacure 819, Irgacure 2959 Darocur 4265 or Degacure 1173 from Ciba or visible light initiator: Irgacure 784 and Camphorquinone (Genocure CQ). In embodiments, the initiator can be a thermal initiator as described in patent publication: WO 2011084141 A1.

In embodiments, the initiator can include one or more of 2,2′-Azobis(2,4-dimethylvaleronitrile), 2,2′-Azobis(2-methylbutyronitrile), 4,4′-Azobis(4-cyanovaleric acid), 2,2′-azobis[N-(2-hydroxyethyl)-2-methylpropionamide], 1,1′-Azobis(cyclohexane-1-carbonitrile. Commercially available initiators, such as Vazo initiators, typically indicate a decomposition temperature for the initiator. In embodiments, the initiator can be selected to have a decomposition point of about 50° C. or higher. In embodiments, initiators are selected to stagger the decomposition temperatures at the various steps, pre-polymerization, shell formation and hardening or polymerizing of the capsule shell material. For example, a first initiator in the dispersed phase can decompose at 55° C., to promote prepolymer formation; a second can decompose at 60° C. to aid forming the shell material. Optionally, a third initiator can decompose at 65° C. to facilitate polymerization of the capsule shell material.

In embodiments, the total amount of initiator can be present in the dispersed phase in an amount of about 0.001 wt % to about 5 wt % based on the total weight of the dispersed phase, or about 0.01 wt % to about 4 wt %, or about 0.1 wt % to about 2 wt %. For example, the total amount of initiator can be present in the dispersed phase in an amount of about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 2 wt %, 3 wt %, 4 wt %, or 5 wt %.

In embodiments, and without intending to be bound by theory it is believed that as the monomers begin polymerizing, the resulting polymer becomes insoluble in the dispersed phase, and further migrates to the interface between the dispersed phase and the continuous phase.

In embodiments, the dispersed phase can include one or more benefit agents. In embodiments, the benefit agent can include one or more of perfumes, brighteners, insect repellants, silicones, waxes, flavors, vitamins, fabric softening agents, skin care agents, UV blocker, enzymes, probiotics, dye polymer conjugate, dye clay conjugate, perfume delivery system, sensates in one aspect a cooling agent, attractants, in one aspect a pheromone, anti-bacterial agents, dyes, pigments, bleaches, and mixtures thereof. In embodiments, the benefit agent can comprise a perfume or perfume delivery system.

In embodiments, the dispersed phase can further include additional components such as excipients, carriers, diluents, and other agents. In embodiments, the benefit agent can be admixed with an oil. In embodiments, the oil admixed with the benefit agent can include isopropyl myristate.

In embodiments, the dispersed phase can further include a process-aid. In embodiments, the process-aid can include one or more of a carrier, an aggregate inhibiting material, a deposition aid, and a particle suspending polymer. Non-limiting examples of aggregate inhibiting materials include salts that can have a charge-shielding effect around the particle, such as magnesium chloride, calcium chloride, magnesium bromide, magnesium sulfate, and mixtures thereof. Non-limiting examples of particle suspending polymers include polymers such as xanthan gum, carrageenan gum, guar gum, shellac, alginates, chitosan; cellulosic materials such as carboxymethyl cellulose, hydroxypropyl methyl cellulose, cationically charged cellulosic materials; polyacrylic acid; polyvinyl alcohol; hydrogenated castor oil; ethylene glycol distearate; and mixtures thereof.

In accordance with embodiments, capsules can be produced according to the methods described herein.

### Test Methods

When encapsulated actives are incorporated into products, the sample preparation for analysis should yield an aqueous suspension of non-aggregated particles for analysis that has not altered the original size distribution. For example, a representative preparation could include that described in WO2018169531A1, pp. 31-34, the disclosure of which is incorporated herein.

### Capsule Size and Distribution Test Method

Capsule size distribution is determined via single-particle optical sensing (SPOS), also called optical particle counting (OPC), using the AccuSizer 780 AD instrument and the accompanying software CW788 version 1.82 (Particle Sizing Systems, Santa Barbara, Calif., U.S.A.), or equivalent. The instrument is configured with the following conditions and selections: Flow Rate=1 ml/sec; Lower Size Threshold=0.50 μm; Sensor Model Number=LE400-05 or equivalent; Autodilution=On; Collection time=60 sec; Number channels=512; Vessel fluid volume=50 ml; Max coincidence=9200. The measurement is initiated by putting the sensor into a cold state by flushing with water until background counts are less than 100. A sample of delivery capsules in suspension is introduced, and its density of capsules adjusted with DI water as necessary via autodilution to result in capsule counts of at least 9200 per ml. During a time period of 60 seconds the suspension is analyzed. The range of size used was from 1 μm to 493.3 μm. Accordingly, the volume distributions and number distributions are calculated as shown and described above.

From the cumulative volume distribution, also the diameter of the percentiles 5 (d₅), 50 (d₅₀) and 90 (d₉₀) are calculated (Percentile j is determined by the cumulative volume distribution where the j percentage of the volume is accumulated (Σ_{d=1um}^{d}^{ⱼ}x_{i,v}=j (%)).

### Delta Fracture Strength Test Method

To measure delta Fracture Strength, three different measurements are made: i) the volume-weighted capsule size distribution; ii) the diameter of 10 individual capsules within each of 3 specified size ranges, and; iii) the rupture-force of those same 30 individual capsules.
a.) The volume-weighted capsule size distribution is determined via single-particle optical sensing (SPOS), also called optical particle counting (OPC), using the AccuSizer 780 AD instrument and the accompanying software CW788 version 1.82 (Particle Sizing Systems, Santa Barbara, Calif., U.S.A.), or equivalent. The instrument is configured with the following conditions and selections: Flow Rate=1 ml/sec; Lower Size Threshold=0.50 μm; Sensor Model Number=Sensor Model Number=LE400-05 or equivalent; Autodilution=On; Collection time=60 sec; Number channels=512; Vessel fluid volume=50 ml; Max coincidence=9200. The measurement is initiated by putting the sensor into a cold state by flushing with water until background counts are less than 100. A sample of delivery capsules in suspension is introduced, and its density of capsules adjusted with DI water as necessary via autodilution to result in capsule counts of at least 9200 per ml. During a time period of 60 seconds the suspension is analyzed. The resulting volume-weighted PSD data are plotted and recorded, and the values of the median, 5^{th} percentile, and 90^{th} percentile are determined.
b.) The diameter and the rupture-force value (also known as the bursting-force value) of individual capsules are measured via a custom computer-controlled micromanipulation instrument system which possesses lenses and cameras able to image the delivery capsules, and which possess a fine, flat-ended probe connected to a force-transducer (such as the Model 403A available from Aurora Scientific Inc, Canada) or equivalent, as described in: Zhang, Z. et al. (1999) “Mechanical strength of single microcapsules determined by a novel micromanipulation technique.” J. Microencapsulation, vol 16, no. 1, pages 117-124, and in: Sun, G. and Zhang, Z. (2001) “Mechanical Properties of Melamine-Formaldehyde microcapsules.” J. Microencapsulation, vol 18, no. 5, pages 593-602, and as available at the University of Birmingham, Edgbaston, Birmingham, UK.
c.) A drop of the delivery capsule suspension is placed onto a glass microscope slide, and dried under ambient conditions for several minutes to remove the water and achieve a sparse, single layer of solitary capsules on the dry slide. Adjust the concentration of capsules in the suspension as needed to achieve a suitable capsule density on the slide. More than one slide preparation may be needed.
d.) The slide is then placed on a sample-holding stage of the micromanipulation instrument. Thirty benefit delivery capsules on the slide(s) are selected for measurement, such that there are ten capsules selected within each of three pre-determined size bands. Each size band refers to the diameter of the capsules as derived from the Accusizer-generated volume-weighted PSD. The three size bands of capsules are: the Median Diameter+/−2 μm; the 5^{th} Percentile Diameter+/−2 μm; and the 90^{th} Percentile Diameter+/−2 μm. Capsules which appear deflated, leaking or damaged are excluded from the selection process and are not measured.
e.) For each of the 30 selected capsules, the diameter of the capsule is measured from the image on the micromanipulator and recorded. That same capsule is then compressed between two flat surfaces, namely the flat-ended force probe and the glass microscope slide, at a speed of 2 μm per second, until the capsule is ruptured. During the compression step, the probe force is continuously measured and recorded by the data acquisition system of the micromanipulation instrument.
f.) The cross-sectional area is calculated for each of the selected capsules, using the diameter measured and assuming a spherical capsule (πr², where r is the radius of the capsule before compression). The rupture force is determined for each selected capsule from the recorded force probe measurements, as demonstrated in Zhang, Z. et al. (1999) “Mechanical strength of single microcapsules determined by a novel micromanipulation technique.” J. Microencapsulation, vol 16, no. 1, pages 117-124, and in: Sun, G. and Zhang, Z. (2001) “Mechanical Properties of Melamine-Formaldehyde microcapsules.” J. Microencapsulation, vol 18, no. 5, pages 593-602.
g.) The Fracture Strength of each of the 30 capsules is calculated by dividing the rupture force (in Newtons) by the calculated cross-sectional area of the respective capsule.
With the recorded data, the Delta Fracture Strength is calculated

$$Delta Fracture Strenght ( \% ) = \frac{FS @ {d}_{5} - FS @ {d}_{90}}{FS @ {d}_{50}} * 100$$

where FS at di is the FS of the capsules at the percentile i of the volume size distribution.

### Shell Thickness Measurement Test Method

The capsule shell thickness is measured in nanometers on 20 benefit agent containing delivery capsules using freeze-fracture cryo-scanning electron microscopy (FF cryoSEM), at magnifications of between 50,000× and 150,000×. Samples are prepared by flash freezing small volumes of a suspension of capsules or finished product. Flash freezing can be achieved by plunging into liquid ethane, or through the use of a device such as a High Pressure Freezer Model 706802 EM Pact, (Leica Microsystems, and Wetzlar, Germany) or equivalent. Frozen samples are fractured while at −120° C., then cooled to below −160° C. and lightly sputter-coated with gold/palladium. These steps can be achieved using cryo preparation devices such as those from Gatan Inc., (Pleasanton, Calif., USA) or equivalent. The frozen, fractured and coated sample is then transferred at −170° C. or lower, to a suitable cryoSEM microscope, such as the Hitachi S-5200 SEM/STEM (Hitachi High Technologies, Tokyo, Japan) or equivalent. In the Hitachi S-5200, imaging is performed with 3.0 KV accelerating voltage and 5 μA-20 μA tip emission current.

Images are acquired of the fractured shell in cross-sectional view from 20 benefit delivery capsules selected in a random manner which is unbiased by their size, so as to create a representative sample of the distribution of capsule sizes present. The shell thickness of each of the 20 capsules is measured using the calibrated microscope software, by drawing a measurement line perpendicular to the tangent of the outer surface of the capsule wall. The 20 independent shell thickness measurements are recorded and used to calculate the mean thickness, and the percentage of the capsules having a selected shell thickness.

The diameter of the 20 cross sectioned capsules is also measured using the calibrated microscope software, by drawing a measurement line perpendicular to the cross section of the capsule.

### Effective Volumetric Core-Shell Ratio Evaluation

The effective volumetric core-shell ratio values were determined as follows, which relies upon the mean shell thickness as measured by the Shell Thickness Test Method. The effective volumetric core-shell ratio of a capsule where its mean shell thickness was measured is calculated by the following equation:

$$\frac{Core}{Shell} = \frac{{( 1 - \frac{2 * Thickness}{{D}_{c a p s}} )}^{3}}{( 1 - {( 1 - \frac{2 * Thickness}{{D}_{c a p s}} )}^{3} )}$$

wherein thickness is the thickness of the shell of an individual capsule and the Dcaps is the diameter of the cross-sectioned capsule.

The twenty independent effective volumetric core-shell ratio calculations were recorded and used to calculate the mean effective volumetric core-shell ratio.

This ratio can be translated to fractional core-shell ratio values by calculating the core weight percentage using the following equation:

$$\% Core = ( \frac{\frac{Core}{Shell}}{1 + \frac{Core}{Shell}} ) * 100$$

and shell percentage can be calculated based on the following equation:

% Shell=100−% Core

### Logarithm of Octanol/Water Partition Coefficient (log P) Test Method

The value of the log of the Octanol/Water Partition Coefficient (log P) is computed for each perfume raw material (PRM) in the perfume mixture being tested. The log P of an individual PRM (log Pi) is calculated using the Consensus log P Computational Model, version 14.02 (Linux) available from Advanced Chemistry Development Inc. (ACD/Labs) (Toronto, Canada), or equivalent, to provide the unitless log P value. The ACD/Labs' Consensus log P Computational Model is part of the ACD/Labs model suite.

The individual log P for each PRM is recorded to calculate the mean log P of the perfume composition by using the following equation:

$$log P = {\sum }_{i = 1}^{n} \frac{{x}_{i}}{100} log {P}_{i}$$

where xi is the % wt of PRM in perfume composition.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. In the EXAMPLE below, the device utilized is illustrated in FIGS. 1 and 2.

### Example

An oil solution consisting of Fragrance Oil (44.86%, wt), Isopropyl Myristate (54.95%, wt), Vazo 52 (0.11%, wt), and Vazo 67 (0.07%, wt), is mixed at RT until mixture is homogeneous.

A second oil solution consisting of Fragrance Oil (96%, wt), and Sartomer CN975 (hexafunctional aromatic urethane-acrylate oligomer, 4.00%, wt), is mixed at RT until mixture in homogeneous.

An aqueous solution (continuous phase) is prepared by adding Selvol 540 (2% wt) to RO water and heating to 90 C for 4h with agitation followed by cooling to RT.

The emulsion is prepared using the oscillatory membranes and reactor apparatus of this invention. A start-up procedure is utilized where the continuous phase fills the chamber described in drawing (#) and flows at a rate of 0.9 kg/min. The oscillation has displacement of 8 mm and frequency of 36 Hz. The two oil phases are mixed inline using a static mixer at a ratio of 53.5:46.5 and passed through a tri-filter cascade unit. Flow rate of oil solution 1 is 0.321 kg/min. Flow rate of oil solution 2 is 0.279 kg/min. The combined oil phase (disperse phase) then enters the reactor and into a manifold that distributes the oil phase uniformly to each membrane tile to pass through the membrane pores at a flux of 40 kg/m2h. Trans-membrane pressure is measured at 2.6 psi. As the disperse phase passes through the oscillating membrane, droplets form and are sheared off the membrane surface to be stabilized by the continuous phase and carried away to the emulsion exit ports. This is a continuous process. Continuous phase flow rate is 0.9 kg/min for a DP concentration of 40%.

The emulsion obtained has a mean droplet size of 26.5 μm and a Coefficient of diameter variation of 30.5% based on volume distribution.

A kilogram of the emulsion is collected in a jacketed vessel and mixed at 50 rpm using a paddle blade and overhead mechanical stirrer. Temperature is raised to 60 C @ 2.5 C/min and held for 45 min. Then temperature is raised to 75 C @ 0.5 C/min and held for 240 min. Then temperature is raised to 90 C @ 0.5 C/min and held for 480 min. Finally, the batch is cooled to RT while maintaining stirring.

The final product is a suspension of encapsulated perfume capsules in PVOH solution. Additional components may be added as needed such as stabilizers and/or preservatives.

The mean size in volume of the population of capsules obtained is 29.7 um with a Coefficient of diameter variation of 31.3%. Active fragrance level in the slurry is 32.97%.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An emulsion forming device comprising:
an outer compartment;
a dispersed phase droplet forming apparatus;
a membrane having one or more pores, an outer surface area and an inner surface area, an average thickness, disposed between the outer compartment and the dispersed phase droplet forming apparatus;
wherein the membrane has a bulge index about 0.1 to about 10 times the average membrane thickness.

2. The emulsion forming device of claim 1, wherein the membrane in combination with a membrane frame forms one or more membrane tiles.

3. The emulsion forming device of claim 2, wherein the one or more membrane tiles have a total membrane outer surface area of about 400 cm² to about 10 cm².

4. The emulsion forming device of claim 3, wherein the one or more membrane tiles comprise one or more membrane tile sectors having a membrane tile sector volume of about 100 mm³ to about 500 mm³.

5. The emulsion forming device of claim 4, wherein the ratio of total membrane outer surface area to total membrane tile sector volume is from about 0.5 to about 2.0.

6. The emulsion forming device of claim 4, wherein the ratio of total membrane outer surface area to total membrane tile sector volume is from about 0.75 to about 1.5.

7. The emulsion forming device of claim 3, wherein the total membrane outer surface area comprises one or more pores forming an open area.

8. The emulsion forming device of claim 7, wherein the open area of the total membrane outer surface area is from about 0.01% to about 20%.

9. The emulsion forming device of claim 1, wherein the bulge about 0.2 to about 5 times the average membrane thickness

10. The emulsion forming device of claim 1, wherein the membrane thickness if from about 1 μm to about 1000 μm.

11. The emulsion forming device of claim 2, wherein the membrane frame comprises one or more ribs forming one or more sectors.

12. The emulsion forming device of claim 11, wherein the membrane frame comprises a membrane frame edge.

13. The emulsion forming device of claim 11, wherein the membrane is attached to the one or more ribs and membrane frame edge.

14. The emulsion forming device of claim 1, wherein the dispersed phase droplet forming apparatus comprises one or more conduits having a feed port.

15. The emulsion forming device of claim 11, wherein the membrane frame comprises a feed hole fluidly connected to the feed port.

16. The emulsion forming device of claim 15, wherein the membrane the feed hole is fluidly connected to has one or more inlets in fluid communication one or more membrane frame sectors.

17. A method of producing emulsions comprising:
providing an emulsion forming device comprising:
an outer compartment;
a dispersed phase droplet forming apparatus;
a membrane having one or more pores, an outer surface area and an inner surface area, an average thickness disposed between the outer compartment and the dispersed phase droplet forming apparatus; wherein the membrane has a bulge index from about 0.1 to about 10 times the average membrane thickness;
wherein a disperse phase is in contact with the inner surface area of the membrane and a continuous phase is in contact with the outer surface area of the membrane;
propelling the dispersed phase through the membrane pores into the continuous phase forming an emulsion comprising a plurality of dispersed phase droplets in the continuous phase.

18. The method of claim 17, wherein the method produces droplets having a coefficient of variation (“CoV”) based on volume percent of less than 50%.

19. The method of claim 18, wherein the method has a dispersed phase throughput of at least about 5 kg/h.

20. The method of claim 17, wherein the droplets comprise polymerizable monomers.

21. The method of claim 20, wherein the droplets are polymerized into at least one of particles or capsules.
